(19) United States
(12) Patent Application Publication
(10) Pub. No.: US 2025/0117389 A1
(43) Pub. Date: Apr. 10, 2025

(54) STATUS-BASED DATA CACHE

(71) Applicant: Capital One Services, LLC, McLean, VA (US)

(72) Inventors: Hong GUO, Glen Allen, VA (US); Dhanveer SINGH, Glen Allen, VA (US); Sandeep ADHIKARI, Gaithersburg, MD (US); Maxwell DEMERS, Chicago, IL (US)

(21) Appl. No.: 18/481,506

(22) Filed: Oct. 5, 2023

(51) Int. Cl. G06F 16/2455; G06F 16/23; G06F 16/2453

(52) U.S. Cl. CPC G06F 16/24552; G06F 16/235; G06F 16/24539

(57) ABSTRACT

In some implementations, a device may receive a request associated with a data value in a data cache. The device may determine, based on the request, that the data value is stored in the data cache, wherein the data value is stored via a data structure in the data cache. The device may determine, based on the data value being stored in the data cache, a status associated with the data value, wherein the status is indicated via the data structure. The device may perform one or more actions in response to the request, wherein the one or more actions are based on the status.

### BACKGROUND

In computing, a data cache is a hardware and/or software component that stores data so that future requests for that data can be served faster. For example, a data cache may be a component of a memory hierarchy that stores frequently accessed or recently used data to improve the overall speed and efficiency of data retrieval. A data cache may reduce the time associated with a central processing unit (CPU) accessing data from a main memory component, such as a random access memory (RAM) component. If requested data is stored in the data cache (e.g., referred to as a cache “hit”), then the requested data may be retrieved from the data cache, which may be faster than accessing the data from the main memory component or retrieving the data from another data source. If requested data is not stored in the data cache (e.g., referred to as a cache “miss”), then the data may be fetched from the main memory component or another data source and stored in the data cache for future use.

### SUMMARY

Some implementations described herein relate to a system for status-based in-process data caches. The system may include one or more memories and one or more processors communicatively coupled to the one or more memories. The one or more processors may be configured to receive a request for a data value in a data cache, wherein the data cache is an in-process data cache. The one or more processors may be configured to determine, based on the request, that the data value is stored in the data cache, wherein the data value is stored via a data structure in the data cache. The one or more processors may be configured to determine, based on the data value being stored in the data cache, a status associated with the data value, wherein the status is indicated via the data structure, and wherein the status is indicative of a storage state of the data value. The one or more processors may be configured to perform one or more actions based on the request, wherein the one or more actions are based on the status.

Some implementations described herein relate to a method for status-based data caches. The method may include receiving, by a device, a request associated with a data value in a data cache. The method may include determining, by the device and based on the request, that the data value is stored in the data cache, wherein the data value is stored via a data structure in the data cache. The method may include determining, by the device and based on the data value being stored in the data cache, a status associated with the data value, wherein the status is indicated via the data structure. The method may include performing, by the device, one or more actions in response to the request, wherein the one or more actions are based on the status.

Some implementations described herein relate to a non-transitory computer-readable medium that stores a set of instructions. The set of instructions, when executed by one or more processors of a device, may cause the device to receive a request for a data value in a data cache, wherein the data cache is an in-process data cache. The set of instructions, when executed by one or more processors of the device, may cause the device to determine, based on the request, whether the data value is stored in the data cache. The set of instructions, when executed by one or more processors of the device, may cause the device to determine, if the data value is stored in the data cache, a status associated with the data value. The set of instructions, when executed by one or more processors of the device, may cause the device to perform one or more actions in response to the request, wherein the one or more actions are based on at least one of the status or whether the data value is stored in the data cache.

### BRIEF DESCRIPTION OF THE DRAWINGS

FIGS. 1A-1B are diagrams of an example associated with status-based data cache, in accordance with some embodiments of the present disclosure.

FIG. 2 is a diagram of an example process associated with status-based data cache, in accordance with some embodiments of the present disclosure.

FIG. 3 is a diagram of an example associated with status-based data cache, in accordance with some embodiments of the present disclosure.

FIG. 4 is a diagram of an example associated with status-based data cache, in accordance with some embodiments of the present disclosure.

FIG. 5 is a diagram of an example environment in which systems and/or methods described herein may be implemented, in accordance with some embodiments of the present disclosure.

FIG. 6 is a diagram of example components of a device associated with a status-based data cache, in accordance with some embodiments of the present disclosure.

FIG. 7 is a flowchart of an example process associated with status-based data cache, in accordance with some embodiments of the present disclosure.

### DETAILED DESCRIPTION

The following detailed description of example implementations refers to the accompanying drawings. The same reference numbers in different drawings may identify the same or similar elements.

A data cache may enable optimized performance and responsiveness for real-time orchestration of various tasks, processes, and/or components in a time-sensitive manner to meet specific requirements. For example, a data cache may store frequently accessed data, reducing the need to repeatedly obtain or retrieve (e.g., fetch) data via slower mechanisms (such as from a main memory or a separate data source). This reduces an amount of time associated with the execution of tasks, ensuring timely responses and minimizing latency associated with performing the tasks. By providing quick access to relevant data, a data cache may enhance the efficiency of real-time orchestration systems, enabling the real-time orchestration systems to quickly process and manage tasks, communicate between components, and/or maintain coordination in high-demand, time-critical environments.

In some examples, a system may use a remote data cache. A remote data cache may store data on a separate node or server in a distributed computing environment. A remote data cache may also be referred to as a distributed data cache. However, remote data caches may increase latency and/or consume network resources associated with inter-process communication and/or network hops that are associated with obtaining or retrieving data from a remote data cache. Therefore, in some examples, the system may use a local data cache, such as an in-process data cache. A local data cache may be a data cache that is stored on the same local server or device as one or more processing components of the system. This may reduce the amount of time associated with accessing data, as compared to retrieving the data from a main memory or a remote location, because the data can be accessed without network communication and/or inter-process communications.

An in-process data cache may be a data cache that operates within the context of a single software process or application. For example, an in-process data cache may be included in a memory of a given application that the in-process data cache serves. In some examples, an in-process data cache may be a localized data cache that resides within a memory space of a software application, resulting in faster data access, improved performance, and/or reduced reliance on external data sources, among other examples.

In some examples, a requestor may request a data value from the data cache (e.g., an in-process data cache). If the data value is not stored in the data cache, then the requestor and/or another component may retrieve the data value from a remote source (e.g., a main memory component or a data source) and store the data value in the data cache. However, while the data value is in the process of being retrieved, other requests (e.g., concurrent or subsequent requests) for other data values stored in the data cache may be blocked. As a result, other requestors may be unable to perform operations associated with data that is stored in the data cache while the data value is in the process of being retrieved. This may increase latency and/or consume processing resources and/or computing resources associated with processes performed by the other requestors because the other requestors may need to wait for the data to be retrieved and/or transmit additional requests for data that is stored in the data cache after the data value has been retrieved. Additionally, while the data value is in the process of being retrieved, other requests (e.g., concurrent or subsequent requests) for the same data value may result in duplicated retrievals of the same data value. This may consume processing resources, network resources, and/or computing resources associated with needlessly retrieving the same data value multiple times.

Some implementations described herein enable a status-based data cache. For example, a data value may be stored in a data cache (e.g., an in-process data cache) in connection with a status. The status may be indicative of a storage state of the data value. For example, the storage state may indicate whether the data value is available to be read or retrieved. As an example, the status may indicate whether the data value is available in the data cache and/or is currently being obtained or retrieved from a separate source (e.g., a data source). As an example, the data value may be stored via a data structure. The data structure may indicate a value of the data value and a status of the data value. In some implementations, the data structure may indicate one or more status update channels. A status update channel may be a communication channel over which the data value is to be indicated when the data value is updated (e.g., as indicated by a change in the status of the data value).

For example, a device may receive a request for a data value in the data cache. The device may determine, based on the request, whether the data value is stored in the data cache. If the data value is not stored in the data cache (e.g., a cache miss), then the device may create a data structure associated with the data value (e.g., where the data structure indicates a temporary data value) with a status indicating that the data value is currently being retrieved or obtained (e.g., an in-progress status, a being queried status, or an in-flight status). If the data value is stored in the data cache (e.g., a cache hit), then the device may determine, based on the data value being stored in the data cache, a status associated with the data value. The device may perform one or more actions based on the request, where the one or more actions are based on the status.

For example, if the status is a ready status (e.g., indicating that the data value is stored in the data cache and has been successfully retrieved and/or stored in the data cache), then the one or more actions may include returning the data value from the data cache. In some implementations, the device may determine whether the data value is to be refreshed (e.g., updated). For example, the request may indicate whether a refreshed data value is requested. If the device determines that the data value is to be refreshed (e.g., in the example where the current status of the data value is the ready status), then the device may update the status to a refreshing status (e.g., that indicates that the data value is being updated or refreshed). As another example, if the status is a refreshing status or a being queried status, then the one or more actions may include registering a status update channel associated with the requester for the data value. For example, the device may store, via the data structure associated with the data value, an indication of a communication channel associated with the requester. The device may determine that a status of a given data value has been changed to a ready status (e.g., from a being queried status or a refreshing status). Based on determining that the status has been changed to the ready status, the device may transmit an indication of the data value via any status update channels indicated by the data structure associated with the data value.

As a result, by storing data values with an associated status, an efficiency of a data retrieval process may be improved. For example, the status may enable the device and/or a requester to identify the storage state of a given data value. By storing data values with an associated status, concurrent and/or different requests for a data value may leverage the status to coordinate operations, thereby reducing a likelihood of duplicate requests to outside sources (e.g., a data source or main memory location) for the data value. Additionally, by performing operations for data retrieval that are based on the status of a requested data value, the device may coordinate operations for multiple requests for the requested data value to reduce a likelihood of duplicate requests to outside sources (e.g., a data source or main memory location) for the requested data value and/or to ensure that other operations of a given requester are not blocked or delayed due to a data value being retrieved from an outside source. This may conserve processing resources, computing resources, and/or network resources that would have otherwise been used in association with the duplicate requests to outside sources. Further, by enabling the data value to have an updated status and to be retrieved via a separate operation (e.g., a separate sequence or a separate thread outside of operations associated with the data cache), a requester that concurrently or subsequently requests the data value may not be blocked or prevented from performing other operations while the data value is being retrieved and/or updated.

For example, by storing status update channels in the data structure for a data value, the device may be enabled to provide updated or refreshed data values via a status update channel without the requester associated with the status update channel waiting for the retrieval process to be completed. For example, the requester may register the status update channel and be enabled to perform other operations while the retrieval process for the data value is being performed. As a result, latency may be reduced that would have otherwise been associated with the requester not performing any operations while the retrieval process for the data value is being performed. Additionally, the requestor may conserve processing resources, computing resources, and/or network resources that would have otherwise been used to transmit one or more additional requests for the data value (e.g., because the data value is automatically transmitted via the status updated channel after the data value has been retrieved or updated).

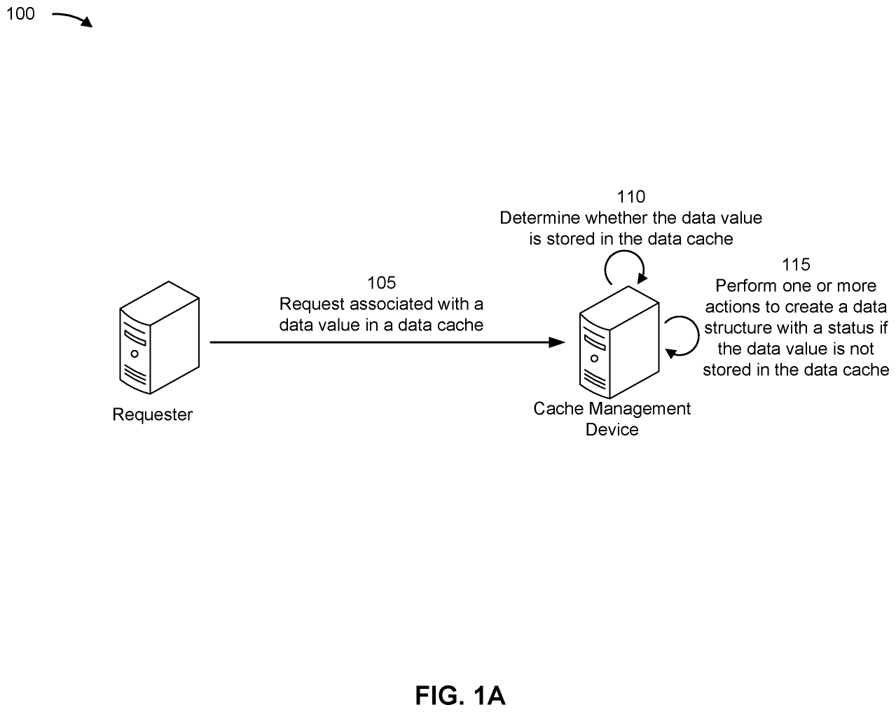

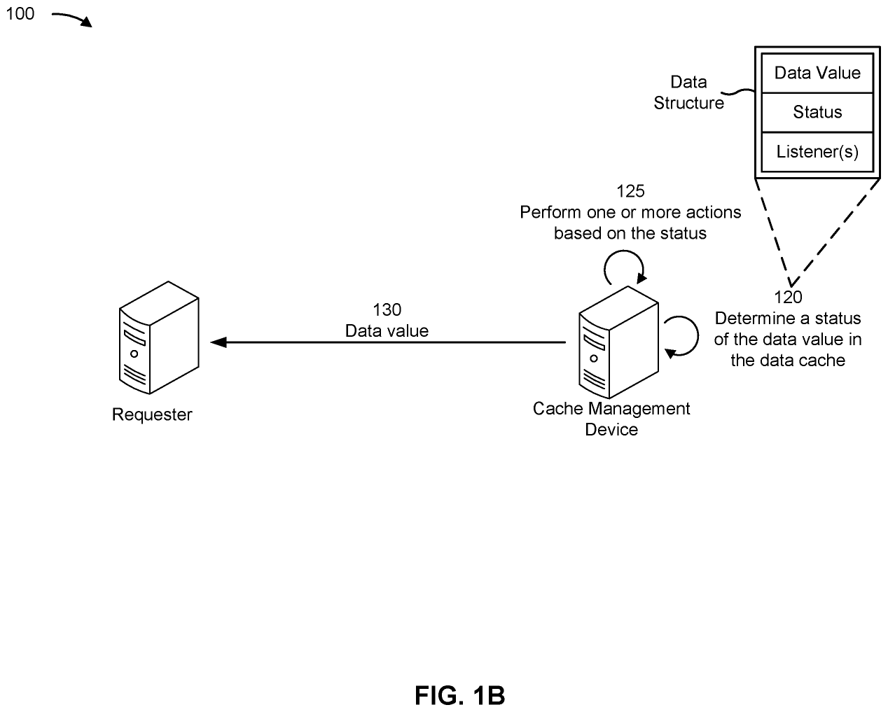

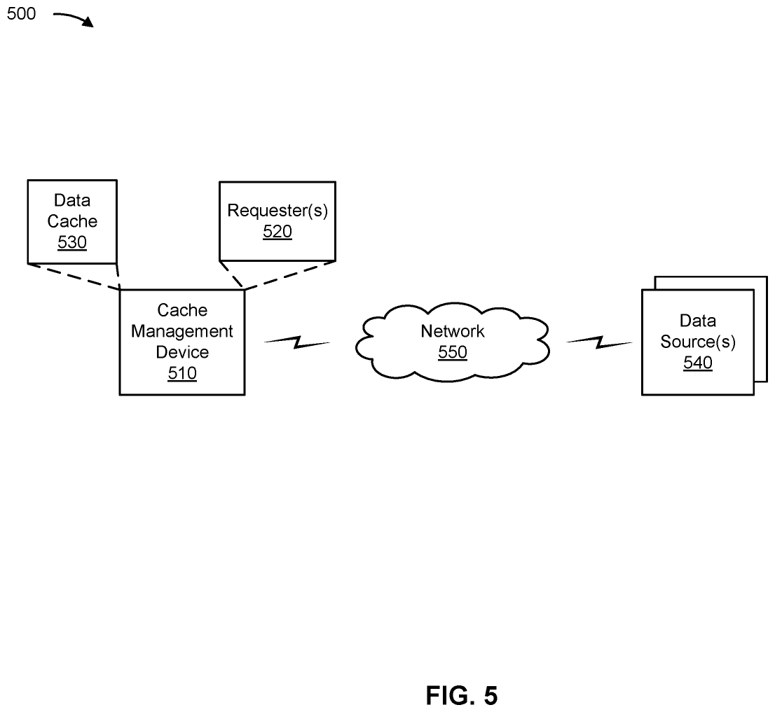

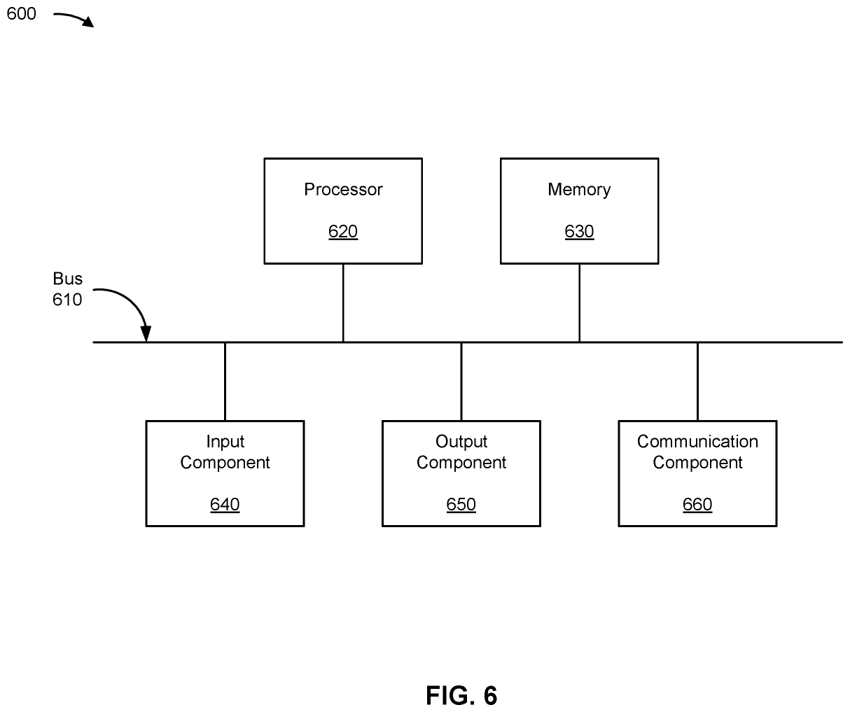

FIGS. 1A-1B are diagrams of an example 100 associated with status-based data cache. As shown in FIGS. 1A-1B, example 100 includes a cache management device and a requestor. These devices are described in more detail in connection with FIGS. 5 and 6.

In some implementations, the cache management device may be associated with a data cache. The data cache may be an in-process data cache. For example, the cache management device, the data cache, and the requester may be associated with an application or a program. For example, the cache management device may include an orchestrator and/or controller associated with an application and the requestor may be a component (e.g., a process or workflow) associated with the application.

For example, the data cache may operate within the context of a single application to enhance the performance and efficiency of data access for the single application by storing frequently used data in memory of the application (e.g., closer to an execution context of the application). In some other implementations, the data cache may be a different type of data cache, such as a remote cache, a distributed cache, and/or another type of local cache, among other examples.

As shown in FIG. 1A, and by reference number 105, the requester may transmit or provide, and the cache management device may receive or obtain, a request associated with a data value in the data cache. For example, the request may indicate a memory address of the data value in the data cache. In some implementations, the request may be associated with a read operation (e.g., a request to read the data value from the data cache). For example, the request may be a request for the data value in the data cache. In other implementations, the request may be associated with a write operation (e.g., a request to write or program the data value in the data cache). For example, the request may indicate or include the data value to be written in the data cache.

As shown by reference number 110, the cache management device may determine whether the data value is stored in the data cache. For example, the cache management device may perform a lookup, using the memory address associated with the data value, to determine whether the data value is stored in the data cache. In some implementations, the cache management device may determine that the data value is stored in the data cache (e.g., a cache hit). In other implementations, the cache management device may determine that the data value is not stored in the data cache (e.g., a cache miss).

As shown by reference number 115, the cache management device may perform one or more actions to create or generate a data structure with a status if the data value is not stored in the data cache. For example, if there is a cache miss, then the cache management device may generate the data structure for the data value. The status may indicate a storage state of the data value. For example, the storage state may indicate an operational status or a retrieval status of the data value. In some implementations, the status may indicate whether the data value is in the process of being retrieved or obtained for storage in the data cache. For example, the status may include a ready status (e.g., indicating that the storage status is a ready state and/or that the data value is stored in the data cache and is available to be accessed), a being queried status (e.g., indicating that the storage status is a being queried state and/or that the data value has a data structure in the data cache, but that the data value is currently in the process of being retrieved from an outside source), a refreshing status (e.g., indicating that the storage status is a refreshing state and/or that the data value has a stored value in a data structure in the data cache, but that the data value is currently in the process of being updated or refreshed from an outside source), and/or an error status (e.g., indicating that the storage status is an error state and/or that a process associated with retrieving the data value from an outside source experienced an error), among other examples.

For example, if the request is associated with a read operation and the cache management device determines that the data value is not stored in the data cache (e.g., a cache miss), then the cache management device may generate a data structure, in the data cache, associated with the data value, with the status indicating that the data value has the being queried status (e.g., an in-progress status or an in-flight status). The cache management device may include a temporary data value in the data cache while the data value is in the process of being retrieved. The cache management device may query a data source associated with the data value to obtain the data value. In some implementations, the cache management device may cause the requestor to query the data source.

In some implementations, retrieving the data value may occur via an operation or process that is separate from the data cache. For example, the querying of the data source may occur via a separate thread from a thread associated with the request. A “thread” may refer to single sequence stream within a process (e.g., an independent sequence of instructions within a program that can be executed concurrently). For example, a thread may be a given execution path. Retrieving the data value via a separate thread may ensure that other requests for the data value (e.g., that occur while the data value is being retrieved) do not result in a delay for other requestors. For example, rather than a thread associated with a concurrent or subsequent request waiting until the data value is retrieved, the thread may be enabled to end or stop (e.g., based on the status of the data value being the being queried status), and another requester associated with the concurrent or subsequent request may be enabled to perform other operations (e.g., via other threads) while the data value is being retrieved.

Based on querying the data source, the cache management device may store, in the generated data structure, the data value obtained or retrieved from the data source. For example, the data source may transmit, and the cache management device and/or the requester may receive, the data value (e.g., in response to the query). In some implementations, the requester may provide, and the cache management device may obtain, the data value (e.g., via a write operation). The cache management device may store, in the generated data structure, the data value based on obtaining or retrieving the data value from the data source.

The cache management device may update, based on storing the data value, the status to indicate a ready status (e.g., a ready state). For example, after the data value has been successfully retrieved and stored in the data cache, the cache management device may update the status indicated by the data structure to be the ready status. In some implementations, based on updating the status to the ready status, the cache management device may transmit, via one or more status update channels (e.g., one or more communication channels), an indication of the data value. For example, as described in more detail elsewhere herein, the one or more status update channels may be registered for the data value based on requests received while the data value has the being queried status. The cache management device may transmit, via the registered status update channel(s) (e.g., indicated by the data structure), the data value that has been stored in the data cache. As a result, the requestor(s) associated with the registered status update channel(s) may obtain the data value without transmitting an additional request for the data value and/or without having a thread being blocked or stalled waiting for the data value to be retrieved.

If the request is associated with a write operation and the cache management device determines that the data value is not stored in the data cache (e.g., a cache miss), then the cache management device may generate a data structure, in the data cache, associated with the data value. The cache management device may include data value indicated by the request in the data cache. The cache management device may cause the status of the data value to be the ready status (e.g., based on writing the data value in the data cache in response to the request).

As shown in FIG. 1B, the cache management device may determine that the data value is stored in the data cache (e.g., a cache hit). For example, the cache management device may determine that a data structure (such as the data structure shown in FIG. 1B) is stored in the memory address indicated by the request.

As shown by reference number 120, the cache management device may determine a status of the data value in the data cache. For example, the cache management device may determine, based on the data value being stored in the data cache, a status associated with the data value. The status may be indicated by the data structure. For example, the data structure may include one or more fields indicting the status of the data value.

As shown by reference number 125, the cache management device may perform one or more actions (e.g., to complete the request) based on the status. In other words, the cache management device may perform different action(s) to complete the request for different statuses of the data value. For example, the cache management device may perform a first one or more actions based on the status being a first status. The cache management device may perform a second one or more actions based on the status being a second status.

In some implementations, the one or more actions may be based on information indicated by the request. For example, the request may indicate whether refreshed or updated data is needed. The one or more actions may be based on whether the request indicates that refreshed or updated data is needed. Additionally, or alternatively, the one or more actions may be based on an amount of time that the data value has been stored in the data cache. For example, the data value may be associated with a valid duration (e.g., a time to live (TTL) value) indicating the duration for which the data value will be considered valid. If the data value has been stored in the data cache for a longer duration than the valid duration, then the cache management device may perform a first one or more actions. If the data value has been stored in the data cache for less than the valid duration, then the cache management device may perform a second one or more actions.

For example, the status of the data value may be the ready status. In such examples, the one or more actions may include transmitting the data value indicated by the data structure. For example, if the status is the ready status, then the cache management device may read the data value from the data structure and return the data value to the requestor (e.g., as shown by reference number 130). In some implementations, transmitting the data value currently indicated by the data structure in the data cache may be based on the request indicating that the data value is not to be refreshed and/or on the data value having been stored in the data cache for less than the valid duration.

In other examples (e.g., where the status is the ready status), the cache management device may determine that the data value is to be refreshed. For example, the cache management device may detect a refresh event associated with the data value. The refresh event may be based on the request and/or an amount of time that the data value has been stored in the data cache, among other examples. For example, the cache management device may determine, based on the request, that the data value is to be refreshed. Additionally, or alternatively, the cache management device may determine, based on the amount of time for which the data value has been stored in the data cache, that the data value is to be refreshed (e.g., based on the amount of time satisfying a validity threshold, where the validity threshold is based on an TTL value associated with the data value or the data cache).

The cache management device may update the status of the data value to the refreshing status (e.g., from the ready status) based on detecting the refresh event. For example, the cache management device may update, based on the request indicating that the data value is to be refreshed, the status to the refreshing status (e.g., to indicate that the storage state is the refreshing state). As another example, the cache management device may update, based on the amount of time for which the data value has been stored in the data cache satisfying a validity threshold, the status to the refreshing status.

The cache management device may query (or may cause the requestor to query), based on updating the status to the refreshing status, a data source to obtain updated data associated with the data value. For example, the querying of the data source may occur via a separate thread from a thread associated with the request. Retrieving the updated data via a separate thread may ensure that other requests for the data value (e.g., that occur while the data value is being retrieved) do not result in a delay for other requestors. For example, rather than a thread associated with a concurrent or subsequent request waiting until the updated data is retrieved, the thread may be enabled to end or stop (e.g., based on the status of the data value being the being queried status), and another requester associated with the concurrent or subsequent request may be enabled to perform other operations (e.g., via other threads) while the data value is being retrieved. Alternatively, if updated data is not needed by another requestor, retrieving the updated data via a separate thread may enable the other requestor to obtain the data value currently stored in the data cache without waiting for the updated data to be retrieved (e.g., thereby reducing a latency associated with the request from the other requestor).

Based on querying the data source, the cache management device may store, in the data structure, the updated data obtained or retrieved from the data source. For example, the data source may transmit, and the cache management device and/or the requester may receive, the updated data (e.g., in response to the query). In some implementations, the requester may provide, and the cache management device may obtain, the updated data (e.g., via a write operation). The cache management device may store, in the data structure, the updated data based on obtaining or retrieving the updated data.

As shown by reference number 130, the cache management device may transmit or provide, and the requester may receive or obtain, the updated data (e.g., in response to the request). Additionally, the cache management device may update, based on obtaining the updated data, the status to the ready status (e.g., to indicate that the storage state is the ready state). As described elsewhere herein, updating the status to the ready status may cause the cache management device to transmit the updated data via one or more status update channels indicated by the data structure. For example, as shown in FIG. 1B, the data structure may indicate one or more listeners. A listener may be a requester that has provided a request associated with the data value while the status of the data value is a status other than the ready status (e.g., is the being queried status, the refreshing status, an error status, or another status). A listener may be associated with a status update channel (e.g., a communication channel over which the listener will monitor for the data value). The cache management device may determine, based on updating the status to the ready status, whether there are any registered listeners associated with the data value. If there are one or more listeners, then the cache management device may transmit the updated data via status update channels for respective listeners of the one or more listeners.

In some implementations, the status of the data value may be the refreshing status. For example, the status may indicate that the storage state is a refreshing state. For example, the refreshing status may indicate that the data value is currently being obtained (e.g., to update or refresh the data value) and that there is a valid data value is available in the data cache (e.g., that is in the process of being updated). In such examples, the one or more actions (e.g., shown by reference number 125) may be based on whether the request indicates that the data value is to be refreshed. For example, if the request indicates that the data value is to be refreshed, then the cache management device may register a communication channel (e.g., a status update channel) associated with the request (e.g., associated with the requester). The requester may monitor for the data value via the communication channel (e.g., in a separate thread from a thread associated with the request). As shown by reference number 130, after the cache management device obtains updated or refreshed data associated with the data value, the cache management device may transmit the updated or refreshed data via the communication channel. The requester may obtain the updated or refreshed data via the communication channel based on monitoring the communication channel. As a result, the thread associated with the request may end after the communication channel is registered and the requester may perform other operation(s) while the updated or refreshed data is retrieved. This improves the efficiency associated with the data retrieval process because the requester is enabled to perform the other operation(s).

In some other implementations, the request may indicate that the data value is not to be refreshed (e.g., where the status of the data value is the refreshing status). In such examples, as shown by reference number 130, the cache management device may transmit, and the requester may receive, the data value currently indicated by the data structure. As a result, latency may be reduced or eliminated that would have otherwise been associated with the cache management device obtaining the updated or refreshed data before transmitting the data value.

In some implementations, the status of the data value may be the being queried status (e.g., an in-progress status or an in-flight status). For example, the status may indicate that the storage state is a being queried state. For example, the being queried status may indicate that the data value is currently being obtained and no valid data value is available in the data cache. In such examples, the one or more actions (e.g., shown by reference number 125) may include registering a communication channel (e.g., a status update channel) associated with the request (e.g., associated with the requester). The requester may monitor for the data value via the communication channel (e.g., in a separate thread from a thread associated with the request). As shown by reference number 130, after the cache management device obtains the data value, the cache management device may transmit the updated or refreshed data via the communication channel (e.g., based on the status being updated to the ready status, as described elsewhere herein). The requester may obtain the data value via the communication channel based on monitoring the communication channel. As a result, the thread associated with the request may end after the communication channel is registered and the requester may perform other operation(s) while the data value is retrieved (e.g., via a separate thread). This improves the efficiency associated with the data retrieval process because the requester is enabled to perform the other operation(s).

In some implementations, the status of the data value may be an error status. For example, the status may indicate that the storage state is an error state. As an example, the error status may indicate that a retrieval attempt associated with the data value experienced an error (e.g., indicating that the data value was not successfully obtained from the data cache and/or from a data source). In some implementations, if the status is the error status, then the cache management device may refrain from attempting to retrieve the data value. For example, the error status may be valid for a given duration or amount of time. After the duration or the amount of time, the cache management device may attempt to obtain the data value, as described in more detail elsewhere herein. If the status is the error status, then the one or more actions (e.g., shown by reference number 125) may include registering a communication channel (e.g., a status update channel) associated with the request (e.g., associated with the requester). The requester may monitor for the data value via the communication channel (e.g., in a separate thread from a thread associated with the request). As shown by reference number 130, after the cache management device successfully obtains the data value, the cache management device may transmit the updated or refreshed data via the communication channel (e.g., based on the status being updated to the ready status, as described elsewhere herein). The requester may obtain the data value via the communication channel based on monitoring the communication channel. As a result, processing resources, computing resources, and/or network resources may be conserved that would have otherwise been associated with attempting to retrieve a data value that is associated with an error. For example, the error may be associated with, or caused by, a data source. Therefore, attempting to repeatedly obtain or retrieve the data value from the data source that is experiencing an error may needlessly consume processing resources, computing resources, and/or network resources. Storing the data value with the error status may enable the cache management device and/or the requester to avoid repeatedly attempting to obtain or retrieve the data value from the data source that is experiencing an error.

As indicated above, FIGS. 1A-1B are provided as an example. Other examples may differ from what is described with regard to FIGS. 1A-1B.

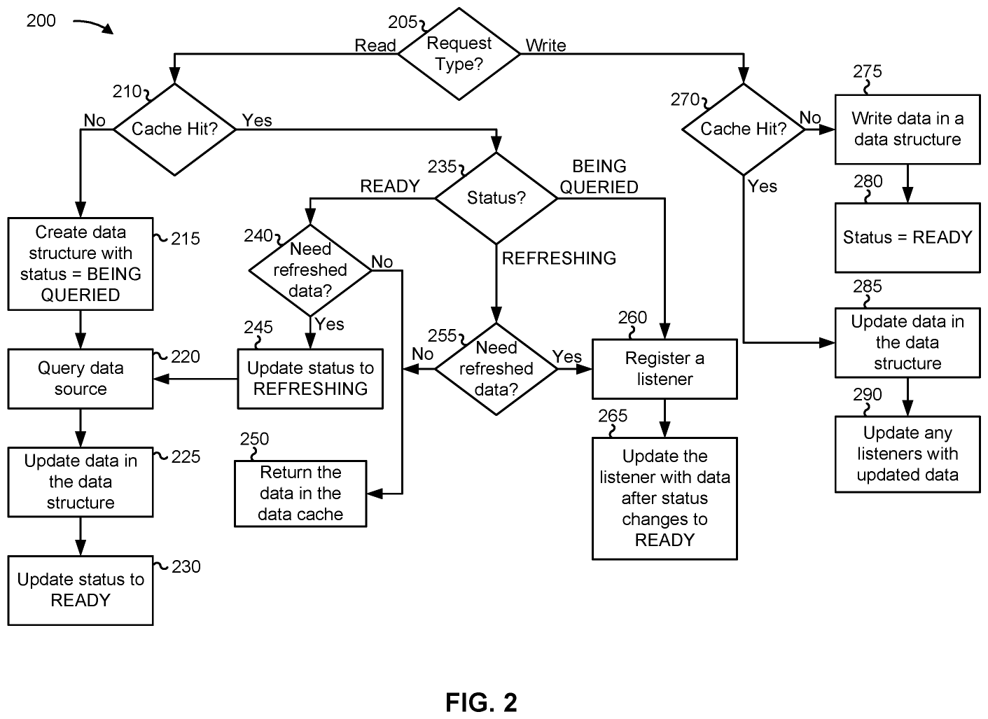

FIG. 2 is a diagram of an example process 200 associated with status-based data cache. FIG. 2 depicts an example flowchart for one or more operations that may be performed to complete a request associated with a status-based data cache. The blocks depicted in FIG. 2 may be performed by the cache management device and/or one or more requesters described herein.

As shown in FIG. 2, the process 200 may include determining a request type associated with the request (block 205). For example, the cache management device may determine the request type. As shown in FIG. 2, the request type may include a read request or a write request.

If the request type is a read request (e.g., block 205—Read), then the process 200 may include determining whether there is a cache hit for the data value requested (block 210). For example, the cache management device may determine whether the data value indicated by the request is stored in the data cache (e.g., in a memory address indicated by the request). If there is not a cache hit (e.g., block 210—No), then the process 200 may include creating a data structure, for the data value, with a status of being queried (block 215). For example, the cache management device may generate a data structure and store the data structure in the data cache in the memory address indicated by the request. The data structure may indicate that the status of the data value is the being queried status. Additionally, the data structure may indicate a temporary data value.

The process 200 may include querying a data source for the data value (block 220). For example, the cache management device and/or the requester may query the data source for the data value. The querying of the data source may occur in via a separate process and/or a separate thread from the request for the data value. In some implementations, the data source may transmit, and the cache management device and/or the requester may receive, the data value. The process 200 may include updating the data in the data structure (block 225). For example, the cache management device may update the data value (e.g., the temporary data value) in the data structure with the data value obtained from the data source. The process 200 may include updating the status of the data value to ready (block 230). For example, the cache management device may update the status indicated by the data structure from a previous status (e.g., the being queried status) to the ready status. In some implementations, if the data structure indicates any listeners (e.g., status update channels), then the cache management device may transmit the data value via the status update channels (e.g., based on updating the status to the ready status).

As shown in FIG. 2, if there is a cache hit (e.g., block 210—Yes), then the process 200 may include determining a status associated with the data value (block 235). For example, the cache management device may determine the status associated with the data value. For example, the cache management device may determine the status of the data value currently stored in the data cache based on the data structure stored in the memory address associated with the data value. If the status is the ready status (block 235—READY), then the process 200 may include determining whether refreshed data is needed (block 240). For example, the cache management device may determine whether refreshed data is needed. In some implementations, the cache management device may determine whether refreshed data is needed based on the request (e.g., the request may indicate whether refreshed data is requested). Additionally, or alternatively, the cache management device may determine whether refreshed data is needed based on amount of time that the data value has been stored in the data cache.

If refreshed data is needed (block 240—Yes), then the process 200 may include updating the status of the data value to refreshing (block 245). For example, the cache management device may update the status of the data value to the refreshing status (e.g., in the data structure stored via the data cache). Based on updating the status to the refreshing status, the process 200 may include similar operations as described in connection with the block 220, the block 225, and the block 230. If refreshed data is not needed (block 240—No), then the process 200 may include returning the data value in the data cache (block 250). For example, the cache management device may return the data value in the data cache. For example, if the status of the data value is the ready status and refreshed data is not needed, then the cache management device may retrieve and provide the data value currently stored in the data structure (e.g., that is located in the memory address indicated by the request).

If the status is the refreshing status (block 235—REFRESHING), then the process 200 may include determining whether refreshed data is needed (block 255). For example, the cache management device may determine whether refreshed data is needed. In some implementations, the cache management device may determine whether refreshed data is needed based on the request (e.g., the request may indicate whether refreshed data is requested). Additionally, or alternatively, the cache management device may determine whether refreshed data is needed based on amount of time that the data value has been stored in the data cache. If refreshed data is not needed (block 240—No), then the process 200 may include similar operations as described in connection with the block 250 (e.g., the data value currently stored in the data cache may be returned in response to the request).

If refreshed data is needed (block 240—Yes), then the process 200 may include registering a listener for the data value (block 260). For example, the cache management device may register the listener for the data value. In some implementations, the listener may be associated with a communication channel (e.g., a status update channel). The cache management device may store an indication of the communication channel in the data structure associated with the data value. The process 200 may include updating the listener with data after the status of the data value changes to the ready status (block 265). For example, the cache management device may update the listener with data after the status of the data value changes to the ready status. As an example, the cache management device may determine that the status of the data value has changed to the ready status. The cache management device may transmit an indication of the data value (e.g., obtained from the data structure after the status of the data value has changed to the ready status) via the communication channel associated with the listener.

If the request type is a write request (e.g., block 205—Write), then the process 200 may include determining whether there is a cache hit for the data value requested (block 270). For example, the cache management device may determine whether the data value indicated by the request is stored in the data cache (e.g., in a memory address indicated by the request). If there is not a cache hit (e.g., block 270—No), then the process 200 may include writing data (e.g., indicated by the request) in the a data structure (block 275). For example, the cache management device may create a data structure, for the data value, with a status of being queried. For example, the cache management device may generate a data structure and store the data structure in the data cache in the memory address indicated by the request. The cache management device may write or store the data value indicated by the request in the data structure. The process 200 may include setting the status of the data structure as ready (block 280). For example, the cache management device may cause the data structure to indicate that the status of the data value is the ready status.

If there is a cache hit (e.g., block 270—Yes), then the process 200 may include updating the data in the data structure that is stored in the data cache (block 285). For example, the cache management device may write or store the data indicated by the request in the data structure that is stored in the memory address indicated by the request. The process 200 may include updating any listeners with the data after updating the data (block 290). For example, the cache management device may update the listener with updated data after updating the data in the data structure as indicted by the request. The cache management device may transmit an indication of the updated data value (e.g., indicated by the request) via the communication channel associated with the listener.

As indicated above, FIG. 2 is provided as an example. Other examples may differ from what is described with regard to FIG. 2.

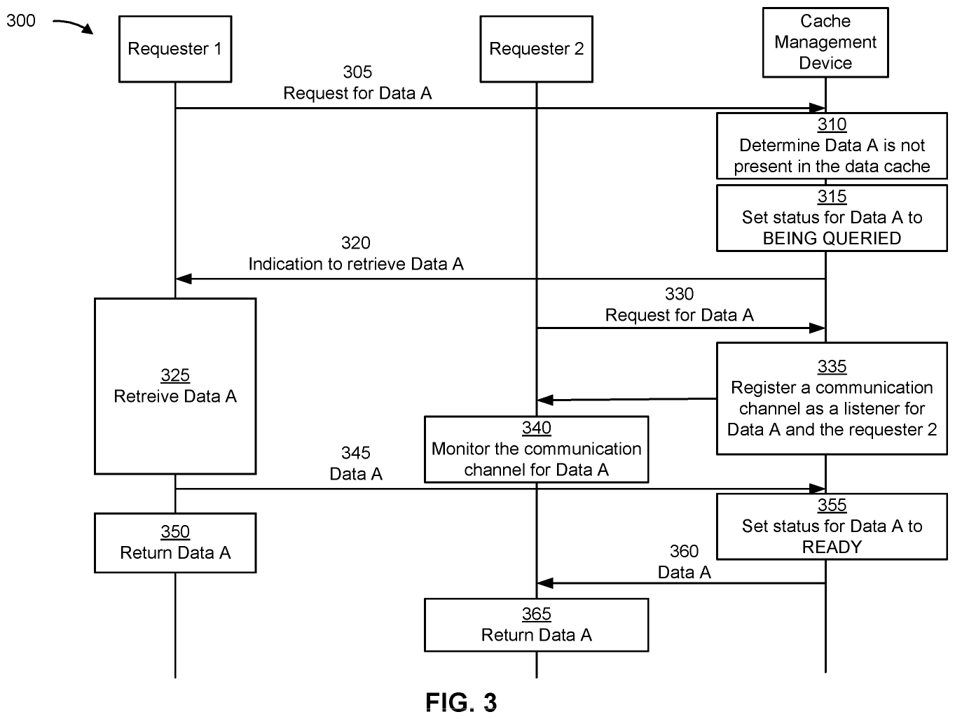

FIG. 3 is a diagram of an example 300 associated with status-based data cache. As shown in FIG. 3, the cache management device, a first requester (requester 1) and a second requester (requester 2) may communicate with each other. In some implementations, the cache management device, the first requester, and the second requester may be associated with, or included in, the same device or system. For example, the cache management device, the first requester, and the second requester may be components of the same device or the same system. As an example, the cache management device, the first requester, and the second requester may be components of a given application. The cache management device may manage a data cache (e.g., an in-process data cache stored in memory of the given application), as described in more detail elsewhere herein.

As shown by reference number 305, the first requester may transmit, and the cache management device may receive, a request for data (e.g., data A). The cache management device may determine whether the data is stored in the data cache. For example, the cache management device may determine whether a data structure is stored in a memory address indicated by the request. As shown by reference number 310, the cache management device may determine that the data (e.g., data A) is not present or stored in the data cache.

The cache management device may generate a data structure for the requested data (e.g., data A). The cache management device may store the data structure in the memory address associated with the requested data. As shown by reference number 315, the cache management device may set the status for the data A to the being queried status (e.g., to indicate that the data A is not currently stored in the data cache and that the data A is in the process of being queried or retrieved).

As shown by reference number 320, the cache management device may transmit, and the requester 1 may receive, an indication to retrieve the data A. For example, the cache management device may transmit, and the first requester may receive, an indication that the data A is not stored in the data cache (e.g., an indication of a cache miss). As shown by reference number 325, the first requester may retrieve the data A (e.g., from a data source). For example, based on receiving the indication that the data A is not stored in the data cache, the first requester may perform one or more operations (e.g., via a thread separate from a thread associated with the request for the data A) to retrieve the data A from a data source.

As shown by reference number 330, the second requester may transmit, and the cache management device may receive, a request for the data (e.g., the data A). For example, the cache management device may receive the request while the first requester is in the process of retrieving the data A. The cache management device may determine that the status of the data is the being queried status. As shown by reference number 335, the cache management device may register a communication channel as a listener for the data A and the second requester. For example, based on determining that the status is the being queried status, the cache management device may register the second requester as a listener for the data A. The cache management device may store an indication of a communication channel associated with the second requester in the data structure associated with the data A. As shown by reference number 340, the second requester may monitor the communication channel for the data A. For example, rather than waiting for the data A to be retrieved, the second requester may perform one or more other operations while the first requester retrieves the data A from the data source.

As shown by reference number 345, the first requester may transmit, and the cache management device may receive, the data A (e.g., based on successfully retrieving the data A from the data source). As shown by reference number 350, the first requester may return the data A. For example, based on obtaining the data A from the data source, the first requester may return the data A to the application and/or component associated with the first requester. The cache management device may store the data A in the data structure associated with the data A. As shown by reference number 355, the cache management device may set the status for the data A to the ready status. For example, based on obtaining the data A from the data source, the status for the data A may be updated from the being queried status to the ready status.

As shown by reference number 360, the cache management device may transmit, and the second requester may receive, the data A. For example, based on updating the status of the data A to the ready status, the cache management device may transmit, and the second requester may receive, the data A via the communication channel that was registered as a listener for the data A. As shown by reference number 365, the second requester may return the data A. For example, based on obtaining the data A from the cache management device via the communication channel, the second requester may return the data A to the application and/or component associated with the second requester. As a result, the second requester is enabled to obtain the data A without transmitting an additional request for the data A. Additionally, only one query to the data source for the data A may be made in response to multiple requests for the data A.

As indicated above, FIG. 3 is provided as an example. Other examples may differ from what is described with regard to FIG. 3.

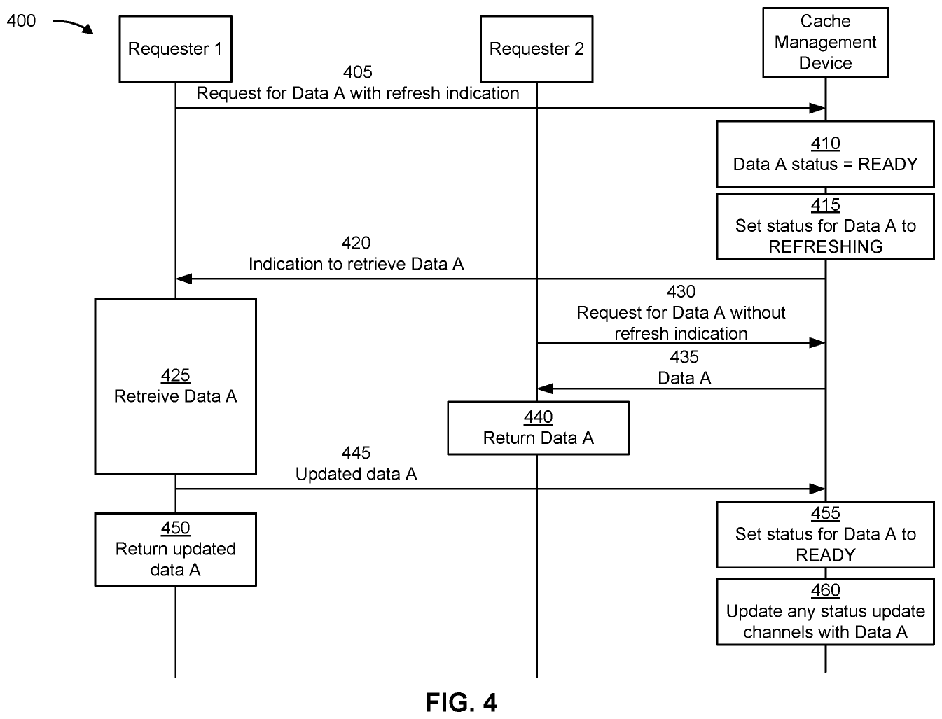

FIG. 4 is a diagram of an example 400 associated with status-based data cache. As shown in FIG. 4, the cache management device, a first requester (requester 1) and a second requester (requester 2) may communicate with each other. In some implementations, the cache management device, the first requester, and the second requester may be associated with, or included in, the same device or system. For example, the cache management device, the first requester, and the second requester may be components of the same device or the same system. As an example, the cache management device, the first requester, and the second requester may be components of a given application. The cache management device may manage a data cache (e.g., an in-process data cache stored in memory of the given application), as described in more detail elsewhere herein.

As shown by reference number 405, the first requester may transmit, and the cache management device may receive, a request for data (e.g., data A). The request may include a refresh indication (e.g., indicating that refreshed data is requested). The cache management device may determine whether the data is stored in the data cache. For example, the cache management device may determine whether a data structure is stored in a memory address indicated by the request. The cache management device may determine that the data (e.g., data A) is stored in the data cache. As shown by reference number 410, the cache management device may determine that the status of the data A is the ready status (e.g., based on an indicated included in the data structure).

As shown by reference number 415, the cache management device may set the status for the data A to the refreshing status (e.g., to indicate that the data A is currently stored in the data cache and that the data A is in the process of being updated). For example, the cache management device may set the status to the refreshing status based on the request indicating that refreshed data is requested (e.g., based on the request including the refresh indication).

As shown by reference number 420, the cache management device may transmit, and the requester 1 may receive, an indication to retrieve the data A. For example, the cache management device may transmit, and the first requester may receive, an indication to update the data A. As shown by reference number 425, the first requester may retrieve the data A (e.g., from a data source). For example, based on receiving the indication that the data A is to be refreshed, the first requester may perform one or more operations (e.g., via a thread separate from a thread associated with the request for the data A) to retrieve the data A from a data source.

As shown by reference number 430, the second requester may transmit, and the cache management device may receive, a request for the data (e.g., the data A). For example, the cache management device may receive the request while the first requester is in the process of retrieving the data A. The request may not include a refresh indication. For example, the request may indicate that refreshed data is not requested. The cache management device may determine that the status of the data is the refreshing status. As shown by reference number 435, the cache management device may transmit, and the requester 2 may receive the data A that is currently stored in the data cache. For example, the cache management device may read the data value from the data structure and return the data value (e.g., the data A) to the requester 2. As shown by reference number 440, the second requester may return the data A. For example, based on obtaining the data A from the cache management device via the communication channel, the second requester may return the data A to the application and/or component associated with the second requester.

As shown by reference number 445, the first requester may transmit, and the cache management device may receive, the updated data A (e.g., based on successfully retrieving the updated data A from the data source). As shown by reference number 450, the first requester may return the updated data A. For example, based on obtaining the data A from the data source, the first requester may return the updated data A to the application and/or component associated with the first requester. The cache management device may store the updated data A in the data structure associated with the data A. As shown by reference number 455, the cache management device may set the status for the data A to the ready status. For example, based on obtaining the updated data A from the data source, the status for the data A may be updated from the refreshing status to the ready status.

As shown by reference number 460, the cache management device may transmit the updated data A via any status update channels (e.g., to registered listeners) indicated via the data structure. For example, based on updating the status of the data A to the ready status, the cache management device may transmit the updated data A via a communication channel that was registered as a listener for the data A. For example, a third requester (e.g., not shown in FIG. 4) may transmit a request for the data A while the status of the data A is the refreshing status. The request from the third requester may indicate that refreshed data is requested (e.g., the request may include a refresh indication). In such examples, the cache management device may register the third requester as a listener (e.g., may store a communication channel associated with the third requester in the data structure associated with the data A). Based on updating the data A in the data cache and/or based on updating the status to the ready status, the cache management device may transmit the updated data A to the third requester via the registered communication channel (e.g., may transmit the updated data A via an registered communication channels).

As indicated above, FIG. 4 is provided as an example. Other examples may differ from what is described with regard to FIG. 4.

FIG. 5 is a diagram of an example environment 500 in which systems and/or methods described herein may be implemented. As shown in FIG. 5, environment 500 may include a cache management device 510, one or more requesters 520, a data cache 530, one or more data sources 540, and a network 550. Devices of environment 500 may interconnect via wired connections, wireless connections, or a combination of wired and wireless connections.

The cache management device 510 may include one or more devices capable of receiving, generating, storing, processing, providing, and/or routing information associated with a status-based data cache (e.g., the data cache 530), as described elsewhere herein. The cache management device 510 may include a communication device and/or a computing device. For example, the cache management device 510 may include a server, such as an application server, a client server, a web server, a database server, a host server, a proxy server, a virtual server (e.g., executing on computing hardware), or a server in a cloud computing system. In some implementations, the cache management device 510 may include computing hardware used in a cloud computing environment.

A requester 520 may include one or more devices capable of receiving, generating, storing, processing, providing, and/or routing information associated with a status-based data cache (e.g., the data cache 530), as described elsewhere herein. The requester 520 may include a communication device and/or a computing device. For example, the requester 520 may include a server, such as an application server, a client server, a web server, a database server, a host server, a proxy server, a virtual server (e.g., executing on computing hardware), or a server in a cloud computing system. In some implementations, the requester 520 may include computing hardware used in a cloud computing environment. In some implementations, the cache management device 510 may include one or more requesters 520 (e.g., as shown in FIG. 5). For example, a requester 520 may be a component of the cache management device 510. As another example, the requester(s) 520 and the cache management device 510 may be components of the same system. In some other implementations, one or more requesters 520 may be separate devices and/or included in separate systems from the cache management device 510.

The data cache 530 may include one or more devices capable of receiving, generating, storing, processing, providing, and/or routing information associated using a status-based data cache, as described elsewhere herein. The data cache 530 may include a communication device and/or a computing device. For example, the data cache 530 may include a level 1 (L1) cache, a level 2 (L2) cache, a level 3 (L3) cache, a unified cache, a write-through cache, a write-back cache, an inclusive cache, an exclusive cache, a cache coherency component, a graphics processing unit (GPU) cache, a local cache, and/or an in-process cache, among other examples. In some implementations, the data cache 530 may be a local cache (e.g., an in-process cache) that is stored on the same local server and/or system as the cache management device 510. For example, the data cache 530 may exist in the same software address space (e.g., software process) as the one or more requesters 520. In some implementations, the data cache 530 and the one or more requesters 520 may be included in the same device (e.g., the same server) and/or the same system.

The data source 540 may include one or more devices capable of receiving, generating, storing, processing, and/or providing information associated with a status-based data cache (e.g., the data cache 530), as described elsewhere herein. The data source 540 may include a communication device and/or a computing device. For example, the data source 540 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 540 may communicate with one or more other devices of environment 500, as described elsewhere herein.

The network 550 may include one or more wired and/or wireless networks. For example, the network 550 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 550 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600 associated with a status-based data cache. The device 600 may correspond to the cache management device 510, a requester 520, the data cache 530, and/or a data source 540. In some implementations, the cache management device 510, a requester 520, the data cache 530, and/or a data source 540 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. In some implementations, the memory 630 may include the data cache 530. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

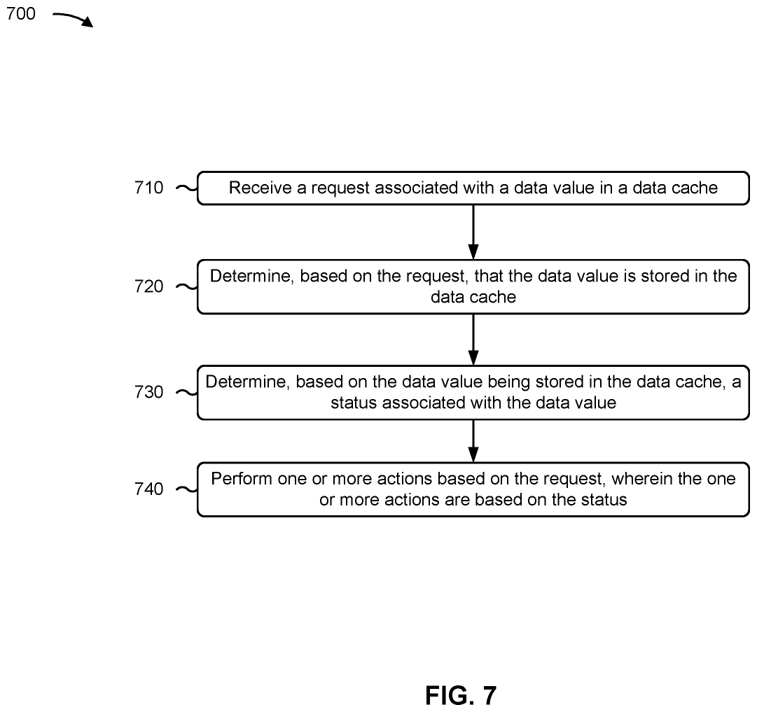

FIG. 7 is a flowchart of an example process 700 associated with status-based data cache. In some implementations, one or more process blocks of FIG. 7 may be performed by the cache management device 510. In some implementations, one or more process blocks of FIG. 7 may be performed by another device or a group of devices separate from or including the cache management device 510, such as a requester 520, the data cache 530, and/or a data source 540. Additionally, or alternatively, one or more process blocks of FIG. 7 may be performed by one or more components of the device 600, such as processor 620, memory 630, input component 640, output component 650, and/or communication component 660.

As shown in FIG. 7, process 700 may include receiving a request associated with a data value in a data cache (block 710). For example, the cache management device 510 (e.g., using processor 620, memory 630, input component 640, and/or communication component 660) may receive a request associated with a data value in a data cache, as described above in connection with reference number 105 of FIG. 1A, reference number 305 and/or reference number 330 of FIG. 3, and/or reference number 405 and/or reference number 430 of FIG. 4. As an example, the request may indicate a memory address associated with the data cache 530.

As further shown in FIG. 7, process 700 may include determining, based on the request, that the data value is stored in the data cache (block 720). For example, the cache management device 510 (e.g., using processor 620 and/or memory 630) may determine, based on the request, that the data value is stored in the data cache, as described above in connection with reference number 110 of FIG. 1A. In some implementations, the data value is stored via a data structure in the data cache. As an example, the cache management device 510 may perform a lookup operation to determine whether the data structure is stored at the memory address indicated by the request.

As further shown in FIG. 7, process 700 may include determining, based on the data value being stored in the data cache, a status associated with the data value (block 730). For example, the cache management device 510 (e.g., using processor 620 and/or memory 630) may determine, based on the data value being stored in the data cache, a status associated with the data value, as described above in connection with reference number 120 of FIG. 1B. In some implementations, the status is indicated via the data structure. As an example, the status may indicate a storage state and/or a retrieval status of the data value. For example, the status may indicate whether the data value is in the process of being retrieved, is stored in the data cache, and/or is being updated or refreshed, among other examples.

As further shown in FIG. 7, process 700 may include performing one or more actions in response to the request, wherein the one or more actions are based on the status (block 740). For example, the cache management device 510 (e.g., using processor 620 and/or memory 630) may perform one or more actions in response to the request, wherein the one or more actions are based on the status, as described above in connection with reference number 125 of FIG. 1B. As an example, the cache management device 510 may perform different action(s) to complete the request for different statuses, as described in more detail elsewhere herein.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1B, and/or FIGS. 2-4. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for status-based in-process data caches, the system comprising:
one or more memories; and
one or more processors, communicatively coupled to the one or more memories, configured to:
receive a request for a data value in a data cache,
wherein the data cache is an in-process data cache;
determine, based on the request, that the data value is stored in the data cache, wherein the data value is stored via a data structure in the data cache;
determine, based on the data value being stored in the data cache, a status associated with the data value,
wherein the status is indicated via the data structure, and
wherein the status is indicative of a storage state of the data value; and
perform one or more actions based on the request,
wherein the one or more actions are based on the status.

2. The system of claim 1, wherein the status indicates that the storage state is a ready state, and wherein the one or more processors, to perform the one or more actions, are configured to:
transmit the data value indicated by the data structure.

3. The system of claim 2, wherein the one or more processors are configured to transmit the data value indicated by the data structure based on the request indicating that the data value is not to be refreshed.

4. The system of claim 2, wherein the one or more processors, to perform the one or more actions, are configured to:
determine, based on the request, that the data value is to be refreshed;
update, based on the request indicating that the data value is to be refreshed, the status to indicate that the storage state is a refreshing state; and
query, based on updating the status, a data source to obtain updated data associated with the data value,
wherein the one or more processors, to transmit the data value indicated by the data structure, are configured to:
transmit the updated data.

5. The system of claim 4, wherein the one or more processors are further configured to:
update, based on obtaining the updated data, the status to indicate that the storage state is the ready state.

6. The system of claim 1, wherein the status indicates that the storage state is a refreshing state, and wherein the one or more actions are based on whether the request indicates that the data value is to be refreshed.

7. The system of claim 6, wherein the request indicates that the data value is to be refreshed, and wherein the one or more processors, to perform the one or more actions, are configured to:
register a communication channel associated with the request; and
transmit, based on the data value being updated, the data value via the communication channel.

8. The system of claim 6, wherein the request indicates that the data value is not to be refreshed, and wherein the one or more processors, to perform the one or more actions, are configured to:
transmit the data value currently indicated by the data structure.

9. A method for status-based data caches, comprising:
receiving, by a device, a request associated with a data value in a data cache;
determining, by the device and based on the request, that the data value is stored in the data cache,
wherein the data value is stored via a data structure in the data cache;
determining, by the device and based on the data value being stored in the data cache, a status associated with the data value,
wherein the status is indicated via the data structure; and
performing, by the device, one or more actions in response to the request,
wherein the one or more actions are based on the status.

10. The method of claim 9, wherein the status indicates a being queried status, and wherein performing the one or more actions comprises:
registering, based on the status being the being queried status, a communication channel associated with the request; and
transmitting, after the data value is obtained, the data value via the communication channel.

11. The method of claim 9, wherein the status indicates a refreshing status or a being queried status, and wherein performing the one or more actions comprises:
storing, in the data structure, an indication of a communication channel associated with the request to be used to communicate an update of the data value.

12. The method of claim 9, wherein the request is a write request to write the data value, and wherein performing the one or more actions comprises:
writing an updated data value, indicated by the request, to the data structure; and
updating the status to indicate a ready status.

13. The method of claim 12, wherein the data structure indicates one or more registered communication channels, and wherein performing the one or more actions comprises:
transmitting, via the one or more registered communication channels and based on writing the updated data value, the updated data value.

14. The method of claim 9, wherein the status indicates a ready status, and performing the one or more actions comprises:
transmitting the data value indicated by the data structure.

15. The method of claim 14, wherein transmitting the data value indicated by the data structure is based on the request indicating that the data value is not to be refreshed.

16. A non-transitory computer-readable medium storing a set of instructions, the set of instructions comprising:
one or more instructions that, when executed by one or more processors of a device, cause the device to:
receive a request for a data value in a data cache,
wherein the data cache is an in-process data cache;
determine, based on the request, whether the data value is stored in the data cache;
determine, if the data value is stored in the data cache, a status associated with the data value; and
perform one or more actions in response to the request,
wherein the one or more actions are based on at least one of the status or whether the data value is stored in the data cache.

17. The non-transitory computer-readable medium of claim 16, wherein the data value is not stored in the data cache, and wherein the one or more instructions, that cause the device to perform the one or more actions, cause the device to:
generate a data structure, in the data cache, associated with the data value, with the status indicating that the data value has a being queried status;
query a data source associated with the data value to obtain the data value; and
store, in the data structure, the data value.

18. The non-transitory computer-readable medium of claim 17, wherein the one or more instructions, that cause the device to perform the one or more actions, cause the device to:
update, based on storing the data value, the status to indicate a ready status.

19. The non-transitory computer-readable medium of claim 16, wherein the status indicates a ready status, and wherein the one or more processors, to perform the one or more actions, are configured to:
transmit, based on the data value being stored in the data cache and the status being the ready status, the data value stored via the data cache.

20. The non-transitory computer-readable medium of claim 16, wherein the status indicates a refreshing status, and wherein the one or more processors, to perform the one or more actions, are configured to:
transmit the data value currently indicated by a data structure in the data cache that stores the data value if the request indicates that the data value is not to be refreshed; or
register, in the data structure, a communication channel associated with the request if the request indicates that the data value is to be refreshed.
